(19) United States
(12) Patent Application Publication
(10) Pub. No.: US 2010/0010086 A1
(43) Pub. Date: Jan. 14, 2010

(54) ANTIMICROBIAL THERAPY FOR INDWELLING CATHETERS AND FOR SANITIZING SURFACES

(76) Inventors: Stephen R. Ash, Lafayette, IN (US); Janusz Steczko, West Lafayette, IN (US)

Correspondence Address: KRIEG DEVAULT LLP, ONE INDIANA SQUARE, SUITE 2800, INDIANAPOLIS, IN, 46204-2079, US

(21) Appl. No.: 12/309,146

(22) PCT Filed: Aug. 3, 2007
(86) PCT No.: PCT/US07/17369

§ 371 Date: Sep. 18, 2009

Related U.S. Application Data
(60) Provisional application No. 60/835,598, filed on Aug. 4, 2006.

(51) Int. Cl. A01N 37/10; A01P 1/00

(52) U.S. Cl. 514/544

(57) ABSTRACT

The invention relates to compositions that provide antimicrobial therapy for indwelling catheters and as topical disinfectants, and methods, devices and kits relating thereto. In one aspect, the invention relates to the infusion of a catheter lock solution into an indwelling catheter. Use of inventive compositions as catheter lock solutions advantageously aid in diminishing the effects of microbial infection in catheters and occlusion of the catheters. In other aspects, antimicrobial compositions are used to topically sanitize wounds, skin areas and/or other surfaces. An antimicrobial composition provided by the invention includes EDTA, a paraben, and optionally one or both of citrate and a photo-oxidant.

### BACKGROUND

This invention generally relates to compositions that provide antimicrobial therapy for indwelling catheters, such as intravascular catheters and other body cavity catheters, and as topical disinfectants useful for sanitizing skin areas, catheter surfaces and other surfaces. In one aspect, the invention relates to infusing a lock solution into an indwelling catheter for extended residence therein to inhibit occlusion and infection in an animal having an indwelling catheter. In another aspect, the invention relates to topical application of an antimicrobial composition to a wound, a skin area, or other surface to be sanitized.

By way of background, catheters are used with increasing frequency to treat patients requiring a variety of medical procedures. Catheters offer many advantages for patients; for example, catheters provide ready access to a patient's vasculature without repeated injections for infusion of fluids such as drugs, nutrients, electrolytes or fluids used in chemotherapy, or for the removal of blood on an intermittent basis. In hyperalimentation treatment, catheters are usually used for infusion of large volumes of fluids. In chemotherapy, catheters are used for infusion of drugs on an intermittent basis, ranging from daily to weekly. For hemodialysis, dual-lumen catheters are often used—usually three times per week—to remove blood from the patient's circulatory system for treatment and to return treated blood back to the patient. One lumen allows removal of blood, while the other lumen allows blood to return.

Catheters are also used to perform other functions and to convey fluids into and out of other body cavities besides veins, as noted above. For example, catheters are placed into arteries to measure blood pressure or remove arterial blood for analysis of gases reflecting lung function; catheters are placed into the peritoneum (the space surrounded by the peritoneal membrane and external to organs in the abdomen) to perform peritoneal dialysis and remove fluids and toxins from the patient; and other catheters are placed into the fluid around the nervous system (cerebral spinal fluid) for removal of this fluid or administration of drugs, and into the subcutaneous space for administration of various drugs or fluids. Such catheters are also subject to infection and to other problems addressed herein.

Catheters can either be acute, or temporary, for short-term use or chronic for long-term treatment. Catheters used to access a patient's bloodstream are commonly inserted into central veins (such as the vena cava) from peripheral vein sites. Another alternative is placement of a dual-lumen chronic central venous dialysis catheter (a “CVDC”) through the internal jugular vein. Adequate hemodialysis requires removal and return of 250-400 mL of blood per minute.

Catheters, especially chronic venous catheters, have drawbacks. The use of both temporary and chronic CVDCs is associated with certain complications that may require catheter removal, catheter replacement and/or administration of medical therapies. They can become occluded by a thrombus, and even if extreme care is taken, the catheters can increase a patient's risk of infection.

Considering first the problem of infection, great care must be taken in the placement and use of a chronic catheter to prevent infection of the patient at the site of access or within the vascular system. The foreign surfaces of catheters can create smooth surfaces at which bacteria can grow, and at which white cells are unable to surround or “phagocytize” the bacteria. One way that a catheter, particularly a chronic catheter such as a CVDC, can give rise to infection is by the migration of bacteria around the catheter across the protective dermal layers. To address this problem, a chronic CVDC usually includes a DACRON cuff attached to the catheter and placed under the skin, which promotes ingrowth of fibrous tissue, fixes the catheter in position, and prevents bacterial migration around the catheter. Most chronic CVDCs in use in the U.S. today have single subcutaneous Dacron® cuffs, placed in the tunnel, 1-4 cm beneath the skin exit site. For dual lumen catheters such as the Ash Split Cath™ and Bard Hickman® catheters, there is one cuff on the catheter. For single-lumen catheters such as Tesio® catheters, there is a single Dacron cuff for each catheter. Cuffed, tunneled CVDCs have a decrease in the rate of exit site infection and catheter-related bloodstream infection (“CRBSI”) versus uncuffed catheters, but these infections still occur. It is believed that the only chronic CVDC in the U.S. at present that does not have a subcutaneous Dacron cuff is the Schon™ catheter. In this catheter a subcutaneous plastic clip connects two Tesio catheters. This clip fixes the catheters in position and apparently prevents pericatheter bacterial migration in a manner similar to a Dacron cuff. Chronic CVDCs are typically made from silicone, polyurethane, or polyurethane derivatives.

For chronic CVDC the most common cause of catheter infection is contamination of the connector hub, and the predominant route of contamination is endoluminal. Catheters, particularly venous catheters, are frequently accessed with syringes, or uncapped and directly connected to IV lines, creating a situation wherein the probability of microbial infection is relatively high. The major determinant of the rate of infection is the frequency with which the catheter hub is opened and the major preventive step is the care in disinfection of the hub and prevention of contamination of the hub. Since endoluminal contamination is the major cause of CRBSI in chronic CVDC, the determinants of infection center on the procedures and handling of the catheter.

Several studies have indicated a rate of bloodstream infection during use of chronic CVDC of 1.1 to 2.2 per 1,000 patient days. One study demonstrated a catheter-related bacteremia rate of 2.2 to 3.8 bacteremic episodes per 1,000 patient days, the lower rate being for catheters placed surgically rather than radiologically. Another study of new tunneled catheters reported that 19% of catheters became infected in a mean of 62 days after catheter placement, representing a rate of 3 infections per 1,000 days. This means that each patient has approximately a 10% chance of developing bloodstream infection during each month. There is no evidence that the rate of CRBSI increases with duration of use of a chronic CVDC. In fact, practical experience and various studies have shown that the rate of CRBSI is the same over the many months of use. Tests indicate that the risk of CRBSI is the same for each period of time that the patient has a catheter. Over time the patient has a higher chance for infection merely because there is more time at risk for infection. The longer the patients have a chronic CVDC, the greater the chance that an infection will occur, but this appears to be merely due to greater time for a constant risk of exposure.

CRBSI in dialysis patients is usually associated with modest symptoms and clears after antibiotic therapy. However, in some patients, signs of infection are much more severe and include all of the symptoms of Systemic Inflammatory Response Syndrome (“SIRS”) (tachycardia, tachypnea, abnormal temperature and white count) plus hypotension. Often these patients must be hospitalized and given intravenous antibiotics. In spite of this care, patients often remain seriously ill until the infected catheter is removed. Studies have shown that CRBSI in hemodialysis patients is caused most frequently by Staphylococcus species such as S. Epidermidis. However, hemodialysis patients are reported to have a greater proportion of CRBSIs due to S. Aureus than do other patient populations and a significant number of infections are due to gram-negative organisms.

The mortality rate following CRBSI in ICU patients has been reported to be 3-25%. It was reported in a recent year that about 60,000 of the 300,000 patients on dialysis in the U.S. had chronic CVDC. Assuming an average incidence of CRBSI of only 21,000 patient-days at risk, about 120 of these patients would be expected to develop CRBSI each day. At the lowest reported mortality rate of 3%, 3-4 ESRD patients die from CRBSI each day. At the highest reported mortality of 25%, 30 ESRD patients die from CRBSI each day. Furthermore, the cost attributable to caring for a single CRBSI episode in hospitalized patients has been reported to be between $3,700 and $29,000. Costs may be higher for patients with CRBSI related to chronic CVDC, given the higher cost of removing and replacing a chronic CVDC. Given the serious consequences of CRBSI, the acute illness of the patient who apparently has bacteremia, and the frequent decision to remove the catheter on the presumption that it is the source, there is a great need for alternative means for fighting catheter infection.

Turning now to the problem of catheter occlusion, intraluminal thrombus formation can significantly impair catheter flow, as can thrombus formation just outside the tip of the catheter. Impairment of the flow may lead to catheter removal or administration of drugs such as tPA to resolve these thromboses. In order to prevent clotting of catheters in blood vessels between uses of a CVDC, catheters have commonly been filled with a lock solution that comprises a concentrated solution of the commonly used anticoagulant, heparin (usually up to 10,000 units of heparin per catheter lumen). When heparin is used for this purpose, the heparin lock solution is injected into each lumen immediately after each use, and typically left in the catheter until the catheter is accessed again. The heparin lock solution is then withdrawn from the catheter before the next use because infusing this amount of heparin into a patient's bloodstream runs the risk of causing excessive bleeding. During the catheter lock procedure the injected volume of solution is preferably exactly the same as the internal volume of the catheter. Even when this volume is injected exactly, however, about ⅓ of the injected anticoagulant volume typically leaves the end of the catheter, causing some systemic anticoagulation of the patient in the hours after a dialysis procedure.

Even with the use of a heparin lock solution, the catheter can become occluded between uses from coagulation of blood in the catheter. Blood may be found in the catheter because, for example, an inadequate volume of heparin was originally infused within the catheter lumen, the heparin diffused or convected from the lumen, or residual blood remains in the lumen during the catheter lock. This often results in formation of a thrombus with concomitant loss of flow through the lumen. The occluded catheters frequently must be removed and/or replaced.

Furthermore, it has been reported that thrombi and fibrin deposits on catheters may serve as a nidus for microbial colonization of the intravascular devices, and that catheter thrombosis might therefore be one factor associated with infection of long-term catheters. Thus, the use of anticoagulants or thrombolytic agents may have a role in the prevention of catheter-related bloodstream infections. However, recent in vitro studies suggest that the growth of coagulase-negative Staphylococci on catheters may also be enhanced in the presence of heparin. In addition, the routine use of heparin to maintain catheter patency, even at doses as low as 250 to 500 units per day, has caused some patients with anti-heparin antibodies to experience heparin-induced thrombocytopenia (HIT Syndrome). This serious syndrome can result in severe and sudden thromboembolic and hemorrhagic complications.

Heparin solutions have no proven intrinsic antiseptic properties to prevent infection after catheter hub contamination. The lack of antiseptic properties of a 5000 U/mL heparin lock was confirmed by a study performed by BEC Laboratories, Inc. under the standard USP antimicrobial effectiveness test protocol. “Antiseptic”, as used herein, means “relating to the prevention of infection by inhibiting the growth of infectious agents”, as defined in Stedman's medical dictionary. Heparin, in fact, may help to promote growth of bacteria within the “biofilm” layer of protein on the catheter surfaces (protamine has the opposite effect). The “biofilm” proteins on the catheter surfaces can protect bacteria from antibiotics and white cells. Also, heparin induces the loss of platelets and, paradoxically, can induce clotting in some patients (the “white clot” syndrome).

In order to achieve a catheter lock solution that is resistant to clotting and resistant to microbial infection, some have proposed the inclusion of antibiotics in heparin lock solutions or prophylactic systemic delivery of antibiotics to patients with CVDCs. However, because of frequent hospitalizations and receipt of antibiotics to treat bloodstream and vascular access infections, hemodialysis patients are at high risk for infection with drug-resistant bacteria. The rapid increase in vancomycin-resistant enterococci (VRE) in the United States has been attributed to use of antiobiotics, especially empirically prescribed vancomycin. Vancomycin is used commonly in dialysis patients for empiric therapy of symptoms of bloodstream infection because it can be administered once a week and is effective against two common pathogens, coagulase-negative Staphylococci and Staphylococcus Aureus. The greater the use of vancomycin, however, the greater the risk of inducing vancomycin-resistant staphylococcus, and if this is the cause of septicemia, there are then no effective drugs with which to treat these patients. Use of prophylactic vancomycin and other antibiotics to prevent catheter infection is therefore discouraged, and alternate means for fighting catheter infection are greatly needed.

In light of the above-described problems, there is a continuing need for advancements in the field of catheter lock solutions and antimicrobial compositions for sanitizing wounds, medical devices and instruments, and other surfaces. The present invention addresses this need and provides a wide variety of benefits and advantages.

### SUMMARY

While the actual nature of the present invention can only be determined with reference to the claims herein, certain forms and features, which are characteristic of the preferred embodiments disclosed herein, are described briefly as follows.

The invention provides compositions that are useful as antimicrobial therapy for indwelling catheters and as topical disinfectants. In one excellent form of the invention, the antimicrobial compositions are used as aqueous catheter lock fluids. In other forms of the invention, the compositions are used for topical treatment of skin or other surface, such as, for example, in wound care or as a pre-operative scrubbing solution. In one embodiment, the fluid comprises citrate, a photo-oxidant, a paraben and EDTA dispersed or dissolved therein. In another embodiment, the fluid comprises citrate, a paraben and EDTA dispersed or dissolved therein. In yet another embodiment, the fluid comprises, EDTA, a photo-oxidant and a paraben dispersed or dissolved therein. In still another embodiment, the fluid comprises EDTA and a paraben dispersed or dissolved therein. The respective formulations provided in accordance with the invention have concentrations effective to inhibit microbial infections. As used herein, the term “inhibit” is intended to encompass effectiveness in preventing microbial infections, killing microbes that come into contact with the solution, preventing significant growth of, or reducing the spread of, a microbial population as would have a detrimental impact on a patient's health, and reducing the likelihood of subsequent infections.

For embodiments used as catheter lock solutions, the relative density of the fluid is preferably selected to be similar to the relative density of a patient's blood, and to thereby optimize the length of time that the solution remains in a catheter. The fluid in certain preferred embodiments also includes a viscosifying agent, and it can optionally also include additional pharmaceutically acceptable materials.

In another form of the invention, a method for treating patients having an indwelling intravascular catheter is provided. In one embodiment, the method comprises selecting a patient having an indwelling catheter defining a lumen therethrough; and infusing an aqueous catheter lock fluid into the lumen, the fluid comprising a combination of ingredients as described herein dispersed or dissolved therein. The invention is advantageously used prophylactically in one embodiment to prevent catheter infections, and is particularly useful in treating a patient having an infection related to the presence of the catheter. A patient that has an indwelling catheter is considered to have a substantial risk of infection by virtue of the passage of the catheter across the patient's protective dermal layer.

In another form of the invention, a method for sanitizing a surface is provided. In one embodiment, the method includes: (1) providing an aqueous solution comprising EDTA and a paraben dispersed or dissolved therein at concentrations whereby the solution is effective to cause at least a 1 log kill in a population of microorganisms on a surface treatment area within about 60 seconds of contact; (2) selecting a surface to be sanitized; and (3) contacting the solution with the surface for a period of time sufficient to cause at least a 6 log decrease in the population of microorganisms. The surface can be, for example, a skin area, a wound, a catheter surface, an medical instrument surface and a table. Sanitizing can be achieved by soaking, rinsing or swabbing ones hands, or a wound, or other surface to be treated in or with a composition described herein for a period of time sufficient to sanitize the hands, wound site or other surface. In one embodiment, the solution further comprises a photo-oxidant, such as, for example, methylene blue, dissolved in the solution. In another embodiment, the solution further comprises citrate dissolved in the solution. In yet another embodiment, the solution further comprises citrate and a photo-oxidant dissolved in the solution.

In still another form of the invention, there is provided an infusion device for infusing a lock fluid into a lumen of a catheter. The device includes a syringe and a pharmaceutically acceptable lock solution contained within the syringe. The lock fluid includes a combination of ingredients as described herein dispersed or dissolved therein In a preferred embodiment, the syringe containing the lock fluid is sterilized.

In still another form, the invention provides devices, methods and compositions relating to the pretreatment of a catheter or other medical implant prior to use. In one embodiment, the catheter is soaked in a solution including EDTA for a period of time, and thereby impregnated with the EDTA to provide a catheter featuring resistance to infection. Such soaking solutions preferably include the EDTA at a high concentration.

In another form, the present invention provides a kit for locking a patient's catheter. The kit includes a container having therein a catheter lock solution comprising a combination of ingredients as described herein dispersed or dissolved therein; and instructions, recorded in a medium, for infusing the solution into a lumen of an indwelling catheter.

Further objects, features, aspects, forms, advantages and benefits shall become apparent from the description and drawings contained herein.

### BRIEF DESCRIPTION OF THE DRAWINGS

FIG. 1 is a perspective view of one embodiment of a catheter and syringe for infusing a lock solution into a catheter for use with the present invention.

### DETAILED DESCRIPTION OF THE PREFERRED EMBODIMENTS

For the purposes of promoting an understanding of the principles of the invention, reference will now be made to the embodiments described herein and specific language will be used to describe the same. It will nevertheless be understood that no limitation of the scope of the invention is thereby intended. Any alterations and further modifications in the described fluids, methods, devices or kits, and any further applications of the principles of the invention as described herein, are contemplated as would normally occur to one skilled in the art to which the invention relates.

The invention provides compositions, methods, devices and kits useful for antimicrobial therapy. In one form of the invention, a catheter lock solution is used to provide anticoagulant and antibacterial properties to an implanted catheter as the lock solution resides in the catheter between uses. As used herein, the term “lock solution” refers to a solution that is injected or otherwise infused into a lumen of a catheter with the intention of allowing at least a portion of a lock solution to remain in the lumen until it is desired or required to access that particular lumen again, typically for additional treatment, i.e., infusion or withdrawal of fluid. It is desired that at least a portion the lock solution remain in the lumen for a desired amount of time lasting from about 1 hour to 3 or 4 days or longer. However, frequently the lock solution is changed on a daily basis during regular care and sterile maintenance of the indwelling catheter. Use of a lock solution in accordance with the present invention provides particular advantages for patients with catheters by inhibiting catheter-related infections and by preventing catheter occlusion.

A catheter used in connection with the present invention typically can either be an acute (temporary) or chronic (long-term) catheter surgically implanted in an animal. The catheter usually is inserted into a vein or artery. The catheter is typically used in varying intervals to administer fluids, nutrients, and medications into the body. The catheter also can be used to withdraw body fluids, such as blood for hemodialysis treatment. When not in use, the catheter remains in its position, commonly an intravascular position, until a subsequent treatment is performed.

The catheters that may be used in accordance with this invention include known and commonly used catheters and are readily available from a variety of commercial sources. The catheters may vary in configuration and size. One type of catheter commonly used in accordance with this invention is a tunneled catheter that includes a cuff for ingrowth of tissue to anchor the catheter. Examples of catheters that may be used include, but are not restricted to, an ASH SPLIT CATH and DUOSPLIT by Ash Access Technology, Inc. (Lafayette, Indiana) and Medcomp (Harleysville, Pa.); Tesio Catheters by Medcomp; PERM CATH by Quinton Instrument Company (Seattle, Wash.); and HICKMAN and VAS CATH by Bard, Inc. (Salt Lake City, Utah). Catheters containing totally subcutaneous ports are also useful in the present invention; examples include LIFESITE by Vasca (Topsfield, Me.); and DIALOCK by Biolink, Inc. of (Boston, Mass.). The catheters are manufactured to function for several months. For example, TESIO catheters can last for up to four years with proper intervention. However, in actual practice prior to the present invention, the catheters have exhibited limited longevity because of occlusion and/or infection. The catheters frequently must be removed and/or replaced upon the occurrence of occlusion and/or infection.

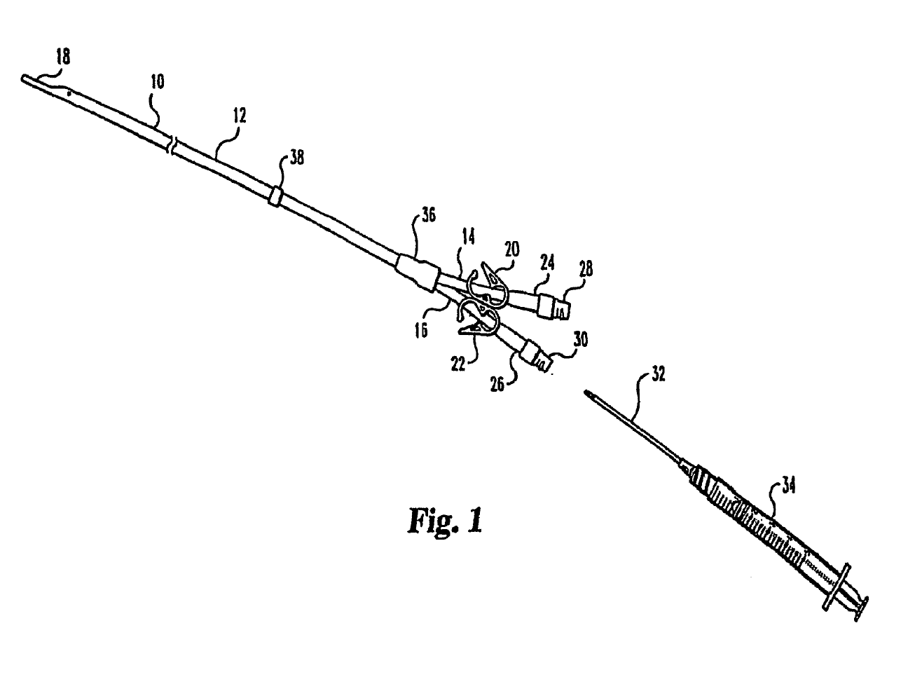

FIG. 1 depicts one example of a catheter 10 for use with this invention. Catheter 10 is a dual lumen catheter and includes an outer sheath 12 having a cuff 38 and first and second lumens 14 and 16, respectively. Lumens 14 and 16 extend from distal tip 18 through sheath 12 and exit from sheath 12 at connection 36. Each of lumens 14 and 16 include releasable clamps 20 and 22, respectively. Each of lumens 14 and 16 terminate in a threaded end 24 and 26, which can be threadedly attached to protective end caps 28 and 30, respectively. Fluids including a lock solution can be infused or withdrawn from each lumen 14 and 16 by making a Luer connection between a syringe 34 and the ends 24 and 26 of catheter 10. Alternatively, fluids can be infused or withdrawn from each lumen by inserting a needle (not shown) through protective end caps 28 and/or 30 after protective end caps 28 and/or 30 have been sterilized by cleaning successively, for example with Betadine and alcohol. As yet another alternative, one or both protective end caps 28 and 30 can be removed and threaded ends 24 and 26 can be threadedly attached via a connector (not shown) to lines for infusion or withdrawal of fluids (not shown). Once a desired treatment session has been completed, the lumens are typically flushed with normal saline, after which a lock solution is injected into each lumen and fresh, sterile protective end caps are placed on the ends 24 and 26 of the catheter. All procedures are performed using standard sterile techniques well known to those skilled in the art. The catheters for use with this invention can be prepared from a variety of materials, including, for example, silicon, polyurethane, polyvinyl, silicone, or silastic elastomer.

In one form of the invention, the catheter lock solution includes citrate, a paraben and EDTA dispersed or dissolved therein. As used herein, the term “EDTA” is used to refer to ethylenediamine-N,N,N′,N′-tetraacetic acid, and also the salts thereof, such as, for example, disodium, trisodium, tetrasodium, dipotassium, tripotassium, dilithium and diammonium salts thereof; and the barium, calcium, cobalt, copper, dysprosium, europium, iron, indium, lanthanum, magnesium, manganese, nickel, samarium, strontium, and zinc chelates thereof. The invention also contemplates that other functionally related chelators can be used as substitutes for EDTA, including, for example, trans-1,2-diaminocyclohexane-N,N,N′,N′-tetraaceticacid monohydrate; N,N-bis(2-hydroxyethyl)glycine; 1,3-diamino-2-hydroxypropane-N,N,N′,N′-te-traacetic acid; 1,3-diaminopropane-N,N,N′,N′-tetraacetic acid; ethylenediamine-N,N′-diacetic acid; ethylenediamine-N,N′-dipropionic acid dihydrochloride; ethylenediamine-N,N′-bis(methylenephosphonic acid) hemihydrate; N-(2-hydroxyethyl)ethylenediamine-N,N′,N′-triacetic acid; ethylenediamine-N,N,N′,N′-tetrakis(methylenephosponic acid); O,O′-bis(2-aminoethyl)ethyleneglycol-N,N,N′,N′-tetraacetic acid; N,N-bis(2-hydroxybenzyl)ethylenediamine-N,N-diacetic acid; 1,6-hexamethylenediamine-N,N,N′,N′-tetraacetic acid; N-(2-hydroxyethyl)iminodiacetic acid; iminodiacetic acid; 1,2-diaminopropane-N,N,N′,N′-tetraacetic acid, nitrilotriacetic acid; nitrilotripropionic acid; the trisodium salt of nitrilotris(methylenephos-phoric acid); 7,19,30-trioxa-1,4,10,13,16,22,27,33-octaazabicyclo[11,11,11]pentatriacontane hexahydrobromide; and triethylenetetramine-N,-N,N′,N″,N′″,N′″-hexaacetic acid. These compositions are considered to be equivalents of EDTA. Further information regarding EDTA and functionally related compositions is provided in U.S. Patent Application Publication Nos. 2004/0110841 by Kite et al. and 2003/0032605 by Raad et al., each of which is incorporated herein by reference in its entirety.

The term “paraben” is used herein to refer to an alkyl ester of p-hydroxybenzoic acid. In one embodiment, the paraben is selected from methyl paraben, ethyl paraben, propyl paraben, butyl paraben and a mixture of any two or more of said parabens. Where the term “butyl is used herein, it is intended to refer to any of four isomeric monovalent radicals C₄H₉ derived from butanes. In another embodiment, the paraben is methyl paraben, propyl paraben or a mixture thereof. The citrate in one preferred embodiment is provided in the form of a citrate salt such as, for example, trisodium citrate dihydrate.

In one embodiment, the lock solution comprises citrate, EDTA and methyl paraben. The amount of methyl paraben in the solution is limited only by the solubility limit of the methyl paraben in the aqueous citrate solution. In an exemplary citrate/EDTA/methyl paraben catheter lock solution, the concentration of methyl paraben is from about 0.005 to about 0.5 percent. In another embodiment, the concentration of methyl paraben is from about 0.01 to about 0.5 percent. As used herein, the term “percent” or the symbol “%” is intended to refer to a concentration measured in grams per 100 milliliters of final solution.

In an alternative embodiment, the lock solution comprises citrate, EDTA and propyl paraben. The amount of propyl paraben in the solution is limited only by the solubility limit of the propyl paraben in the aqueous citrate solution. In an exemplary citrate/EDTA/propyl paraben catheter lock solution, the concentration of propyl paraben is from about 0.005 to about 0.5 percent. In another embodiment, the concentration of propyl paraben is from about 0.01 to about 0.2 percent.

In another exemplary embodiment, the lock solution comprises citrate, EDTA and a mixture of methyl paraben and propyl paraben. In an exemplary citrate/methyl paraben/EDTA/propyl paraben catheter lock solution, the total concentration of the parabens is from about 0.05 to about 0.6 percent. In another embodiment, the total concentration of the parabens is from about 0.1 to about 0.3 percent. In yet another embodiment, the concentration of methyl paraben is from about 0.05 to about 0.5 percent and the concentration of propyl paraben is from about 0.005 to about 0.5 percent. In still another embodiment, the concentration of methyl paraben is from about 0.05 to about 0.3 percent and the concentration of propyl paraben is from about 0.005 to about 0.3 percent. In a particular embodiment that has been found to have excellent properties, methyl paraben has a concentration of about 0.15 percent and propyl paraben has a concentration of about 0.015 percent in the fluid.

Although it is not intended that the present invention be limited by any theory whereby it achieves its advantageous results, it is believed that the citrate and the EDTA prevent coagulation by chelating the calcium in the adjacent blood. Increasing the concentration of citrate and/or EDTA decreases the effect of calcium to catalyze numerous reactions that form blood clots. Citrate and EDTA are preferably present in the catheter lock solution at respective concentrations that are sufficiently high to significantly decrease the ionized calcium concentration in blood, even when the lock solution is diluted by blood at the tip of a catheter. In one preferred embodiment, sodium citrate is present in a lock solution at a concentration of from about 1.5 to about 50 percent. In another embodiment, citrate is present at a concentration of from about 10 to about 50 percent. In another embodiment, citrate is present at a concentration of from about 1.5 to about 23 percent. In yet another embodiment, citrate is present at a concentration of from about 1.5 to about 15 percent. In another embodiment, citrate is present at a concentration of up to about 20 percent. In one embodiment, EDTA is present in a lock solution at a concentration of from about 0.03 to about 10 percent. In another embodiment, EDTA is present at a concentration of from about 0.1 to about 5 percent. In another embodiment, EDTA is present at a concentration of from about 0.1 to about 1.5 percent.

The concentrations of citrate set forth above are presented as “percent” of mostly trisodium citrate in water. When various combinations of salts of citrate are combined, such as trisodium citrate with citric acid, for example to obtain a certain pH, it is more accurate and helpful to express the concentration of citrate as a molar concentration, with a certain percentage of salts being sodium, hydrogen or other cations. Thus, in one embodiment, citrate is present at a concentration of at least about 0.004 Molar, more preferably from about 0.01 to about 1.0 Molar. Another embodiment includes citrate at a concentration of from about 0.1 to about 0.5 Molar. Yet another embodiment includes citrate at a concentration of about 0.24 Molar. In a preferred embodiment of the invention, the pH of the inventive catheter lock solution is from about 4 to about 8.

In one preferred embodiment, an inventive catheter lock solution includes citrate (provided, for example, in the form of trisodium citrate dihydrate) at a concentration of about 7%, EDTA at a concentration of about 1% and a paraben component having a concentration of from about 0.1% to about 0.2%. In one preferred embodiment about 90% of the paraben component is methyl paraben and about 10% of the paraben component is propyl paraben.

In another form of the invention, there is provided a catheter lock solution including EDTA and a paraben dispersed or dissolved therein. In one embodiment, the paraben is selected from methyl paraben, ethyl paraben, propyl paraben, butyl paraben and a mixture of any two or more of said parabens. In another embodiment, the paraben is methyl paraben, propyl paraben or a mixture thereof.

In one embodiment, the lock solution comprises EDTA and methyl paraben. The amount of methyl paraben in the solution is limited only by the solubility limit of the methyl paraben in the aqueous EDTA solution. In an exemplary EDTA/methyl paraben catheter lock solution, the concentration of methyl paraben is from about 0.005 to about 0.5 percent. In another embodiment, the concentration of methyl paraben is from about 0.01 to about 0.5 percent. In an alternative embodiment, the lock solution comprises EDTA and propyl paraben. The amount of propyl paraben in the solution is limited only by the solubility limit of the propyl paraben in the aqueous citrate solution. In an exemplary EDTA/propyl paraben catheter lock solution, the concentration of propyl paraben is from about 0.005 to about 0.5 percent. In another embodiment, the concentration of propyl paraben is from about 0.01 to about 0.2 percent.

In another preferred embodiment, the lock solution comprises EDTA and a mixture of methyl paraben and propyl paraben. In an exemplary EDTA/methyl paraben/propyl paraben catheter lock solution, the total concentration of the parabens is from about 0.05 to about 0.6 percent In another embodiment, the total concentration of the parabens is from about 0.1 to about 0.3 percent. In yet another embodiment, the concentration of methyl paraben is from about 0.05 to about 0.5 percent and the concentration of propyl paraben is from about 0.005 to about 0.5 percent. In still another embodiment, the concentration of methyl paraben is from about 0.05 to about 0.3 percent and the concentration of propyl paraben is from about 0.005 to about 0.3 percent. In a particular embodiment that has been found to have excellent properties, methyl paraben has a concentration of about 0.15 percent and propyl paraben has a concentration of about 0.015 percent in the fluid.

EDTA is preferably present in the catheter lock solution at a concentration sufficiently high to significantly decrease the ionized calcium concentration in blood, even when the lock solution is diluted by blood at the tip of a catheter. In one preferred embodiment, EDTA is present in a lock solution at a concentration of from about 0.03 to about 10 percent. In another embodiment, EDTA is present at a concentration of from about 0.1 to about 5 percent. In yet another embodiment, EDTA is present at a concentration of from about 0.5 to about 1.5 percent. In a preferred embodiment of the invention, the pH of the inventive catheter lock solution is from about 4 to about 8. In one preferred embodiment, an inventive catheter lock solution includes EDTA at a concentration of about 1% and a paraben component having a concentration of from about 0.1% to about 0.2%. In one preferred embodiment about 90% of the paraben component is methyl paraben and about 10% of the paraben component is propyl paraben.

In another form of the invention, there is provided a catheter lock solution including citrate, EDTA, a paraben and a photo-oxidant The use of methylene blue and other photo-oxidants in a catheter lock solution is discussed in U.S. Patent Application Publication No. US 2004/0092890, which is hereby incorporated herein by reference in its entirety. The present inventors have discovered that the inclusion of a photo-oxidant in a catheter lock solution along with citrate, EDTA and a paraben results in enhanced antimicrobial properties. In one preferred embodiment, the photo-oxidant is methylene blue. Alternative photo-oxidants that can be selected for use in accordance with the invention include, without limitation, Rose Bengal, hypericin, methylene violet, proflavine, riboflavin, rivanol, acriflavine, toluide blue, trypan blue, neutral red and mixtures thereof.

In one embodiment of the invention, the concentration of the photo-oxidant in the solution is up to about 1500 mg/100 ml. In another embodiment, the concentration of the photo-oxidant in the fluid is from about 1 to about 1500 mg/100 ml. In still another embodiment, the concentration of the photo-oxidant in the fluid is from about 1 to about 1000 mg/1100 ml. In yet another embodiment, the concentration of the photo-oxidant in the fluid is from about 1 to about 100 mg/100 ml. In a further embodiment, the concentration of the photo-oxidant in the fluid is from about 1 to about 50 mg/100 ml. In another embodiment, the concentration of the photo-oxidant in the fluid is about 10 mg/100 ml.

In addition to enhancement of the antimicrobial properties of a catheter lock solution, a photo-oxidant can also be advantageous in that it imparts a color to the solution. The present application also contemplates the use of other coloring agents in catheter lock solutions made or used in accordance with the invention Coloring agents can be used, for example, to provide a safety function, indicating to observers that the catheter contains a catheter lock solution. For example, methylene blue at a concentration of 10 mg/100 ml has a dark blue color in a syringe, and a noticeably blue color within the clear external segments of the catheter. Over time, the methylene blue solution lightly stains the inside of catheters made of polyurethane or silicone, but the injected lock solution still makes the segments noticeably darker in color. Therefore the presence of the lock solution is recognizable. In addition, it is possible to use a system of color coordination in which different coloring agents are used to identify, for example, different citrate concentrations, different EDTA concentrations, different paraben concentrations or mixtures, or perhaps lock solutions that include other additives, such as, for example, other anticoagulants or antibiotics.

In another form of the invention, there is provided a catheter lock solution including EDTA, a paraben and a photo-oxidant. In one preferred embodiment, the photo-oxidant is methylene blue. Alternative photo-oxidants that can be selected for use in accordance with the invention include, without limitation, Rose Bengal, hypericin, methylene violet, proflavine, riboflavin, rivanol, acriflavine, toluide blue, trypan blue, neutral red and mixtures thereof.

In one embodiment of the invention, the concentration of the photo-oxidant in the solution is up to about 1500 mg/100 ml. In another embodiment, the concentration of the photo-oxidant in the fluid is from about 1 to about 1500 mg/100 ml. In still another embodiment, the concentration of the photo-oxidant in the fluid is from about 1 to about 1000 mg/100 ml. In yet another embodiment, the concentration of the photo-oxidant in the fluid is from about 1 to about 100 mg/100 ml. In a further embodiment, the concentration of the photo-oxidant in the fluid is from about 1 to about 50 mg/100 ml. In another embodiment, the concentration of the photo-oxidant in the fluid is about 10 mg/100 ml.

A common problem that is encountered in connection with catheter lock solutions is that the solutions do not permanently stay within the catheter. Some of the catheter lock solution tends to exits the end of the catheter during the infusion (often about ⅓ of the injected volume) when a volume is injected into the catheter equal to the lumen volume of the catheter. In addition, the portion remaining in the end of the catheter is typically washed out slowly by flow of blood through the side-boles of the catheter (if present). Another portion of the lock solution slowly diffuses from the body of the catheter through the end of the catheter during the time that lapses between dialysis treatments.

In the case of concentrated citrate, for example, gravitational effects also come into play. It is of course understood that the densities of citrate solutions increase as the concentrations of citrate therein increase. The relative density of 23% citrate, for example, is 1.120, which is significantly higher than the relative density of blood. Thus, when the patient is standing, the segment of the inner portion of the catheter in the vena cava is vertical. Gravitational force causes citrate at this concentration to slowly leave the catheter. In the laboratory, in some types of catheters positioned vertically (such as the double-D shaped Ash Split Cath catheters), 23% citrate lock can be shown to slowly exit from the distal part of the catheter over 3-5 days, into blood or blood substitute (with the same relative density). In other catheters (such as cylindrical Tesio catheters) the 23% citrate lock does not exit over time.

In vitro studies have indicated that the density of a lock solution is important in determining the length of time that the lock solution remains in the catheter. The relative density of blood with hematocrit of 32% is approximately 1.040. If a catheter lock solution with relative density higher than this is placed into a catheter positioned vertically, the lock solution will exit from the catheter at a slow rate. Increasing the viscosity with polymeric substances such as PEG slows but does not prevent the egress of the lock solution. Therefore, in certain embodiments of the invention, the concentrations of ingredients in a lock solution are selected such that the density of the lock solution is sufficiently close to the density of the patient's blood that the solution does not exit the catheter during the lock period to an unacceptable degree.

In one aspect of the invention, therefore, a catheter lock solution provided by the present invention has a density of from about 1.000 to about 1.300 g/ml. In another embodiment, a lock solution comprising citrate and a paraben has a density of from about 1.000 to about 1.080 g/ml. In still another embodiment, a lock solution is provided having a density of from about 1.030 to about 1.050 g/ml. In yet another embodiment, an inventive lock solution has a density of from about 1.035 to about 1.045 g/ml. It is understood that the density of a given patient's blood may differ from the density of the blood of another patient. Thus, the present invention also contemplates matching the relative density of a catheter lock solution to within a predetermined tolerance of the relative density of whole blood of a given patient (such as, for example, within 0.040 g/ml of the relative density of the patient's blood). Closely matching the densities has the advantageous effect of aiding in the retention of the catheter lock solution within the catheter between treatments. When the relative densities are relatively close; gravitational force does not tend to urge the catheter lock solution out of the catheter when the patient is upright. Similarly blood will not enter the catheter when the catheter is upward directed as in the femoral vein when the patient is standing (as can happen with a low-density catheter lock such as heparin).

In another aspect of the invention, the catheter lock solution may also include an agent to modify viscosity, as described in International Publication No. WO 00/10385, which is incorporated herein by reference in its entirety. The presence of a viscosifying agent is particularly useful, for example, when the relative density of a given catheter lock solution is not the same as the density of a patient's blood.

Therefore, in certain preferred embodiments, a lock solution is provided that also comprises one or more agents to adjust viscosity to help retain the lock within the catheter for a desired amount of time. It is well known that catheters are manufactured to have a variety of configurations and lumen diameters. For example, catheters can include single or double lumens. The double lumens can be fused adjacent to each other or they can be concentric. The lumens can have varying cross-sectional areas and shapes, ranging from substantially circular to substantially ovoid. As discussed above, a phenomenon common to most lock solutions is that a portion of the solution at the distal end of the lumen diffuses into the patient's blood stream and is replaced in the catheter by blood. The rate of diffusion of a lock solution from a lumen can be influenced not only by the density of the lock solution, but also by the cross-sectional shape and area of the particular lumen(s) and the viscosity of the lock solution. A lock solution of the present invention is preferably prepared to have a viscosity and density such that a substantial portion of the lock solution does not diffuse or flow out of a catheter lumen under normal circumstances within several days.

Viscosifying agents that can advantageously be selected for use in accordance with the present invention include those pharmaceutically acceptable agents known or commonly used in treatment of animals including humans. Examples include, but are not limited to, dextran, polyethylene glycol, glycerin, polygeline, and non-metabolizable sugars such as sorbitol and mannitol and mixtures of these compounds. Viscosifying agents that increase the viscosity of a lock solution allow a higher concentration of citrate to be used without having an unacceptable degree of egress of the lock solution from the catheter due to high density of the lock solution.

While it is understood that optimal viscosity and density are dependent upon the shape and size of a particular lumen, a person of ordinary skill in the art, in view of the description herein, can readily determine a desired density and viscosity for a particular catheter without undue experimentation. It is of course understood that the need for viscosifying agents is reduced or eliminated in a lock solution having a relatively lower concentration of citrate and a density closely matched to that of blood.

An inventive lock solution can be prepared to include a variety of other pharmaceutically acceptable agents. For example, the lock solution can include salts, such as, for example, sodium chloride or other sodium salts. The lock solution can also include a variety of other antibacterial, antimicrobial and anticoagulant agents. Such antibacterial and antimicrobial agents are well known to those skilled in the art and can include, without limitation, gentamicin, vancomycin, and mixtures of these agents. Additional anticoagulant agents that can be included in an inventive catheter lock solution include, for example, heparin, urokinase, tissue plasminogen activation (tPA) and mixtures of these agents. When the anticoagulant includes heparin, the heparin is preferably present at a concentration of from about 100 units/ml to about 10,000 units/ml.

By “pharmaceutically acceptable”, it is meant that the lock solution and the included salts and other additives are, within the scope of sound medical judgment, suitable for use in contact with tissues of humans and lower animals without undue toxicity, irritation, allergic response, and the like, and are commensurate with the reasonable benefit/risk ratio. For example, pharmaceutically acceptable salts are well-known in the art, and examples can be found in S. M. Berge et al. described in detail in J. Pharmaceutical Science, 66:1-19, 1977. It is also typically necessary that a composition be sterilized to reduce the risk of infection.

In another form of the invention, compositions as described above are used as topical antimicrobial therapy. A topical antimicrobial composition can be used, for example, to sanitize one's hands or other skin area, to cleanse a wound, or to sanitize or cleans other surfaces, devices or the like. In one form of the invention, the topical antimicrobial composition includes citrate, a paraben and EDTA dispersed or dissolved therein. The invention also contemplates that other functionally related chelators can be used as substitutes for EDTA, as described herein. In one embodiment, the paraben is selected from methyl paraben, ethyl paraben, propyl paraben, butyl paraben and a mixture of any two or more of said parabens. In another embodiment, the paraben is methyl paraben, propyl paraben or a mixture thereof. The citrate in one preferred embodiment is provided in the form of a citrate salt such as, for example, trisodium citrate dihydrate.

In one embodiment, the topical antimicrobial composition comprises citrate, EDTA and methyl paraben. The amount of methyl paraben in the solution is limited only by the solubility limit of the methyl paraben in the aqueous citrate solution. In an exemplary citrate/EDTA/methyl paraben topical antimicrobial composition, the concentration of methyl paraben is from about 0.005 to about 0.5 percent. In another embodiment, the concentration of methyl paraben is from about 0.01 to about 0.5 percent.

In an alternative embodiment, the topical antimicrobial composition comprises citrate, EDTA and propyl paraben. The amount of propyl paraben in the solution is limited only by the solubility limit of the propyl paraben in the aqueous citrate solution. In an exemplary citrate/EDTA/propyl paraben topical antimicrobial composition, the concentration of propyl paraben is from about 0.005 to about 0.5 percent. In another embodiment, the concentration of propyl paraben is from about 0.01 to about 0.2 percent.

In another preferred embodiment, the topical antimicrobial composition comprises citrate, EDTA and a mixture of methyl paraben and propyl paraben. In an exemplary citratelmethyl paraben/EDTA/propyl paraben topical antimicrobial composition, the total concentration of the parabens is from about 0.05 to about 0.6 percent. In another embodiment, the total concentration of the parabens is from about 0.1 to about 0.3 percent. In yet another embodiment, the concentration of methyl paraben is from about 0.05 to about 0.5 percent and the concentration of propyl paraben is from about 0.005 to about 0.5 percent. In still another embodiment, the concentration of methyl paraben is from about 0.05 to about 0.3 percent and the concentration of propyl paraben is from about 0.005 to about 0.3 percent. In a particular embodiment that has been found to have excellent properties, methyl paraben has a concentration of about 0.15 percent and propyl paraben has a concentration of about 0.015 percent in the fluid.

In one preferred embodiment, sodium citrate is present in a topical antimicrobial composition at a concentration of from about 1.5 to about 50 percent. In another embodiment, citrate is present at a concentration of from about 10 to about 50 percent. In another embodiment, citrate is present at a concentration of from about 1.5 to about 23 percent. In yet another embodiment, citrate is present at a concentration of from about 1.5 to about 15 percent. In another embodiment, citrate is present at a concentration of up to about 20 percent. In one embodiment, EDTA is present in a topical antimicrobial composition at a concentration of from about 0.03 to about 10 percent. In another embodiment, EDTA is present at a concentration of from about 0.1 to about 5 percent. In another embodiment, EDTA is present at a concentration of from about 0.5 to about 1.5 percent In a preferred embodiment of the invention, the pH of the inventive topical antimicrobial composition is from about 4 to about 8. In one preferred embodiment, an inventive topical antimicrobial composition includes citrate (provided, for example, in the form of trisodium citrate dihydrate) at a concentration of about 7%, EDTA at a concentration of about 1% and a paraben component having a concentration of from about 0.1% to about 0.2%. In one preferred embodiment about 90% of the paraben component is methyl paraben and about 10% of the paraben component is propyl paraben.

In another form of the invention, there is provided a topical antimicrobial composition including EDTA and a paraben dispersed or dissolved therein. In one embodiment, the paraben is selected from methyl paraben, ethyl paraben, propyl paraben, butyl paraben and a mixture of any two or more of said parabens. In another embodiment, the paraben is methyl paraben, propyl paraben or a mixture thereof. In one embodiment, the topical antimicrobial composition comprises EDTA and methyl paraben. The amount of methyl paraben in the solution is limited only by the solubility limit of the methyl paraben in the aqueous EDTA solution. In an exemplary EDTA/methyl paraben topical antimicrobial composition, the concentration of methyl paraben is from about 0.005 to about 0.5 percent. In another embodiment, the concentration of methyl paraben is from about 0.01 to about 0.5 percent. In an alternative embodiment, the topical antimicrobial composition comprises EDTA and propyl paraben. The amount of propyl paraben in the solution is limited only by the solubility limit of the propyl paraben in the aqueous citrate solution. In an exemplary EDTA/propyl paraben topical antimicrobial composition, the concentration of propyl paraben is from about 0.005 to about 0.5 percent. In another embodiment, the concentration of propyl paraben is from about 0.01 to about 0.2 percent.

In another preferred embodiment, the topical antimicrobial composition comprises EDTA and a mixture of methyl paraben and propyl paraben. In an exemplary EDTA/methyl paraben/propyl paraben topical antimicrobial composition, the total concentration of the parabens is from about 0.05 to about 0.6 percent In another embodiment, the total concentration of the parabens is from about 0.1 to about 0.3 percent. In yet another embodiment, the concentration of methyl paraben is from about 0.05 to about 0.5 percent and the concentration of propyl paraben is from about 0.005 to about 0.5 percent. In still another embodiment, the concentration of methyl paraben is from about 0.05 to about 0.3 percent and the concentration of propyl paraben is from about 0.005 to about 0.3 percent. In a particular embodiment that has been found to have excellent properties, methyl paraben has a concentration of about 0.15 percent and propyl paraben has a concentration of about 0.015 percent in the fluid. In a preferred embodiment of the invention, the pH of the inventive topical antimicrobial composition is from about 4 to about 8. In one preferred embodiment, an inventive topical antimicrobial composition includes EDTA at a concentration of about 1% and a paraben component having a concentration of from about 0.1% to about 0.2%. In one preferred embodiment about 90% of the paraben component is methyl paraben and about 10% of the paraben component is propyl paraben.

In another form of the invention, there is provided a topical antimicrobial composition including citrate, EDTA, a paraben and a photo-oxidant. The inclusion of a photo-oxidant in a topical antimicrobial composition along with citrate, EDTA and a paraben results in enhanced antimicrobial properties. In one preferred embodiment, the photo-oxidant is methylene blue. Alternative photo-oxidants that can be selected for use in accordance with the invention include, without limitation, Rose Bengal, hypericin, methylene violet, proflavine, riboflavin, rivanol, acriflavine, toluide blue, trypan blue, neutral red and mixtures thereof.

In one embodiment of the invention, the concentration of the photo-oxidant in the solution is up to about 1500 mg/100 ml. In another embodiment, the concentration of the photo-oxidant in the fluid is from about 1 to about 1500 mg/100 ml. In still another embodiment, the concentration of the photo-oxidant in the fluid is from about 1 to about 1000 mg/100 ml. In yet another embodiment, the concentration of the photo-oxidant in the fluid is from about 1 to about 100 mg/100 ml. In a further embodiment, the concentration of the photo-oxidant in the fluid is from about 1 to about 50 mg/100 ml. In another embodiment, the concentration of the photo-oxidant in the fluid is about 10 mg/100 ml.

In another form of the invention, there is provided a topical antimicrobial composition including EDTA, a paraben and a photo-oxidant. In one preferred embodiment, the photo-oxidant is methylene blue. Alternative photo-oxidants that can be selected for use in accordance with the invention include, without limitation, Rose Bengal, hypericin, methylene violet, proflavine, riboflavin, rivanol, acriflavine, toluide blue, trypan blue, neutral red and mixtures thereof. In one embodiment of the invention, the concentration of the photo-oxidant in the solution is up to about 1500 mg/100 ml. In another embodiment, the concentration of the photo-oxidant in the fluid is from about 1 to about 1500 mg/100 ml. In still another embodiment, the concentration of the photo-oxidant in the fluid is from about 1 to about 1000 mg/100 ml. In yet another embodiment, the concentration of the photo-oxidant in the fluid is from about 1 to about 100 mg/100 ml. In a further embodiment, the concentration of the photo-oxidant in the fluid is from about 1 to about 50 mg/100 ml. In another embodiment, the concentration of the photo-oxidant in the fluid is about 10 mg/100 ml.

In another form of the invention, there are provided methods of inhibiting infections. In one embodiment, the invention provides a method of inhibiting infections in an animal having an indwelling intravascular catheter. In one aspect, therefore, the invention provides a method that includes selecting a patient having an indwelling catheter defining a lumen therethrough, and infusing into the lumen an aqueous catheter lock solution made or selected in accordance with the invention. In a preferred manner of practicing the invention, the method comprises infusing an amount of the lock solution that is from about 80% to about 120% of the internal volume of the catheter being locked. Once a lock solution is infused into the lumen of a catheter in accordance with the invention, it is preferably allowed to remain until it is time to access that particular catheter or lumen again. It is desirable to remove the catheter lock before starting the dialysis procedure or using the catheter for fluid infusion, especially if the catheter lock solution includes heparin.

In other aspects of the invention, the catheter lock solution may be injected into catheters used for access to other body spaces besides veins or arteries. For example, catheters used in peritoneal dialysis access the peritoneum (the space defined by the peritoneal membrane and exterior to the organs in the abdomen). These catheters also have a risk of bacterial and fungal contamination. After draining and infusing peritoneal dialysate solutions, a lock solution including citrate and a paraben is infused into the catheter. Other catheters with risk of infection include catheters in the urinary bladder, the cerebral spinal fluid (around the central nervous system) and the subcutaneous space (under the skin).

The invention also provides a method of inhibiting infections by sanitizing a surface, such as a surgeon's hands, a medical implant device, a medical instrument, a wound, or other surface to be sanitized. In accordance with the invention, such a surface is sanitized by rinsing, soaking, swabbing or otherwise contacting a surface to be sanitized with a topical antimicrobial composition.

In another aspect, the invention involves an infusion device for infusing a lock solution into a lumen of a catheter. The infusion device includes a syringe and a pharmaceutically acceptable lock solution contained within the syringe. The lock solution is made or selected in accordance with the invention. In a preferred embodiment, the syringe containing the lock solution is sterilzed. The syringe can be advantageously used to infuse a catheter lock solution into a catheter that has an injection port affixed thereto by attaching a needle to the syringe and injecting the needle into the port. Alternatively the syringe can be used by uncapping a catheter and attaching the syringe directly to the catheter.

The present invention also contemplates the pretreatment of a catheter to provide an infection-resistant catheter. In an advantageous aspect of the invention, therefore, a catheter selected for implantation into a patient, such as, for example, into a vascular site of a patient, can be pretreated with a solution including EDTA to coat and impregnate the catheter surfaces with EDTA, thereby providing an infection-resistant catheter. Generally, it is sufficient to soak the catheter in an excess volume of an aqueous EDTA solution, followed by washing in water or in a solution mimicking physiological conditions of use to remove non-absorbed material. In a preferred embodiment, it is desirable to soak the catheter in a high concentration of EDTA, including concentrations that exceed the normal solubility limits of the paraben in water. In certain embodiments, therefore, the catheter is soaked in a solution of EDTA dissolved in a different solvent in which higher concentrations can be achieved. The catheter, pretreated in this manner, has an increased resistance to infection when it is placed into position, particularly when an antimicrobial catheter lock solution is placed therein.

It is also contemplated that a wide variety of other polymeric medical devices can be treated as described above. For example, medical devices that are amenable to coating and impregnation by an EDTA solution include non-metallic materials such as thermoplastic or polymeric materials. Examples of such materials are rubber, plastic, polyethylene, polyurethane, silicone, Gortex (polytetrafluoroethylene), Dacron (polyethylene tetraphthalate), Teflon (polytetrafluoroethylene), latex, elastomers and Dacron sealed with gelatin, collagen or albumin. Devices especially suited for application of the antimicrobial combinations of this invention include, for example, peripherally insertable central venous catheters, dialysis catheters, long term tunneled central venous catheters, peripheral venous catheters, short-term central venous catheters, arterial catheters, pulmonary artery Swan-Ganz catheters, urinary catheters, long term urinary devices, tissue bonding urinary devices, vascular grafts, vascular catheter ports, wound drain tubes, hydrocephalus shunts, peritoneal catheters, pacemaker capsules, small or temporary joint replacements, urinary dilators, heart valves and the like.

One embodiment of the present invention, therefore, is a method for impregnating a non-metallic medical implant with EDTA comprising the steps of forming an aqueous solution of an effective concentration of EDTA to inhibit the growth of bacterial and fungal organisms; and applying the solution to at least a portion of a medical implant under conditions where the EDTA permeates the material of the medical implant. The EDTA solution can have a wide variety of concentrations, depending upon the amount of EDTA one desires to become impregnated in the catheter or other device. In addition, the amount of time that the catheter or other device is soaked in the solution can be varied to vary the degree of impregnation. Typically it will be desired to soak the catheter for at least about an hour, and often significantly longer.

After the impregnated implant is removed from the solution, and optionally allowed to dry, the implant is preferably rinsed with a liquid to remove excess EDTA solution from the surface thereof. It is of course understood that the invention can be used in certain embodiments to pre-treat a portion of a catheter or other device. In the case of an intravascular catheter, for example, it may be desirable to pre-treat only the lumen of the catheter. This can be done by simply placing a pretreatment solution into the lumen of the catheter rather than soaking the entire catheter. Alternatively, it is possible to pre-treat only a portion of a catheter that will reside within a patient's artery or vein, or to pre-treat only the portion that lies transcutaneously.

In another aspect of the invention, there is provided a catheter lock kit. In one preferred embodiment, a kit includes a container having therein a catheter lock solution made or selected in accordance with the invention; and instructions, recorded in a medium, for infusing the solution into a lumen of an indwelling catheter.

As will be appreciated by those of ordinary skill in the art, a wide variety of embodiments have been described and are contemplated by the present invention. In one form of the invention, there is provided an aqueous catheter lock solution comprising citrate, a paraben and EDTA dispersed or dissolved therein. In one embodiment, the solution comprises a paraben selected from the group consisting of methyl paraben, ethyl paraben, propyl paraben, butyl paraben and mixtures of any two or more of said members. In another embodiment, the solution comprises methyl paraben. For example, the invention contemplates an embodiment in which the concentration of methyl paraben in the solution is from about 0.005 to about 0.5 percent. In another embodiment, the solution comprises propyl paraben. For example, the invention contemplates an embodiment in which the concentration of propyl paraben in the solution can be from about 0.005 to about 0.5 percent. In yet another embodiment, the solution comprises a mixture of methyl paraben and propyl paraben. For example, the invention contemplates an embodiment in which the concentration of methyl paraben in the solution is from about 0.05 to about 0.5 percent and the concentration of propyl paraben in the solution is from about 0.005 to about 0.5 percent.

In one embodiment, the concentration of citrate in the solution is from about 1.5 to about 50% by weight. In another embodiment, the concentration of citrate in the solution is from about 10 to about 50% by weight. In yet another embodiment, the concentration of citrate in the solution is from about 1.5 to about 23% by weight. For example, the invention contemplates an embodiment in which the citrate has a concentration of from about 1.5 to about 50 percent and the paraben has a concentration of from about 0.005 to about 0.6 percent. In certain preferred embodiments, the citrate is provided in the solution in the form of trisodium citrate dihydrate.

In one embodiment, the concentration of EDTA in the solution is from about 0.03 to about 10% by weight. In another embodiment, the concentration of EDTA in the solution is from about 0.1 to about 5% by weight. In yet another embodiment, the concentration of EDTA in the solution is from about 0.5 to about 1.5% by weight. In one embodiment, the pH of the solution is from about 4 to about 8. In another embodiment, the relative density of the solution is from about 1.000 to about 1.300 g/ml. In yet another embodiment, the solution also includes a viscosifying agent. For example, the viscosifying agent can be one or more of dextran, polyethylene glycol, glycerin, polygeline and non-metabolizable sugars such as sorbitol and mannitol. In one embodiment, the solution further includes a photo-oxidant dissolved in the solution. The photo-oxidant can be, for example, one or more of methylene blue, Rose Bengal, hypericin, methylene violet, proflavine, riboflavin, rivanol, acriflavine, toluide blue, trypan blue and neutral red. In one preferred embodiment, the photo-oxidant comprises methylene blue. For example, the invention contemplates an embodiment in which the concentration of methylene blue in the solution is up to about 1500 mg/100 ml.

In another aspect of the invention, there is provided a catheter lock solution comprising EDTA and a paraben dispersed or dissolved therein. In one embodiment, the solution comprises a paraben selected from the group consisting of methyl paraben, ethyl paraben, propyl paraben, butyl paraben and mixtures of any two or more of said members. In another embodiment, the solution comprises methyl paraben. For example, the invention contemplates an embodiment in which the concentration of methyl paraben in the solution is from about 0.005 to about 0.5 percent. In another embodiment, the solution comprises propyl paraben. For example, the invention contemplates an embodiment in which the concentration of propyl paraben in the solution can be from about 0.005 to about 0.5 percent. In yet another embodiment, the solution comprises a mixture of methyl paraben and propyl paraben. For example, the invention contemplates an embodiment in which the concentration of methyl paraben in the solution is from about 0.05 to about 0.5 percent and the concentration of propyl paraben in the solution is from about 0.005 to about 0.5 percent.

In one embodiment, the concentration of EDTA in the solution is from about 0.03 to about 10% by weight. In another embodiment, the concentration of EDTA in the solution is from about 0.1 to about 5% by weight. In yet another embodiment, the concentration of EDTA in the solution is from about 0.5 to about 1.5% by weight. For example, in a preferred embodiment, the EDTA has a concentration of from about 0.03 to about 10 percent and the paraben has a concentration of from about 0.005 to about 0.6 percent In certain preferred embodiments, the EDTA is provided in the solution in the form of the tetrasodium salt of EDTA. In one embodiment, the pH of the solution is from about 4 to about 8. In another embodiment, the relative density of the solution is from about 1.000 to about 1.300 g/ml. In yet another embodiment, the solution also includes a viscosifying agent. For example, the viscosifying agent can be one or more of dextran, polyethylene glycol, glycerin, polygeline and non-metabolizable sugars such as sorbitol and mannitol. In one embodiment, the solution further includes a photo-oxidant dissolved in the solution. The photo-oxidant can be, for example, one or more of methylene blue, Rose Bengal, hypericin, methylene violet, proflavine, riboflavin, rivanol, acriflavine, toluide blue, trypan blue and neutral red. In one preferred embodiment, the photo-oxidant comprises methylene blue. For example, the invention contemplates an embodiment in which the concentration of methylene blue in the solution is up to about 1500 mg/100 ml.

In another aspect of the invention, there is provided a method for treating a patient that includes: (1) selecting a patient having an indwelling catheter defining a lumen therethrough; and (2) infusing an aqueous catheter lock solution into the lumen, the solution comprising EDTA and a paraben dispersed or dissolved therein. In one embodiment, the catheter is selected from the group consisting of an intravascular catheter and a body cavity catheter. In another embodiment, the solution further comprises a photo-oxidant, such as, for example, methylene blue, dissolved in the solution. In yet another embodiment, the solution further comprises citrate dissolved in the solution. In still another embodiment, the solution further comprises citrate and a photo-oxidant dissolved in the solution.

In another aspect of the invention, there is provided a method for sanitizing a surface that includes: (1) providing an aqueous solution comprising EDTA and a paraben dispersed or dissolved therein at concentrations whereby the solution is effective to cause at least a 1 log kill in a population of microorganisms on a surface treatment area within about 60 seconds of contact; (2) selecting a surface to be sanitized; and (3) contacting the solution with the surface for a period of time sufficient to cause at least a 6 log decrease in the population of microorganisms. The surface can be, for example, a skin area, a wound, a catheter surface, an medical instrument surface and a table. In one embodiment, the solution further comprises a photo-oxidant, such as, for example, methylene blue, dissolved in the solution. In another embodiment, the solution further comprises citrate dissolved in the solution. In yet another embodiment, the solution further comprises citrate and a photo-oxidant dissolved in the solution.

In another aspect, the invention provides an infusion device for infusing a lock solution into a lumen of a catheter. The device includes a syringe and a pharmaceutically acceptable lock solution contained within the syringe. In one embodiment, the lock solution includes citrate, a paraben and EDTA dispersed or dissolved therein. In another embodiment, the lock solution includes EDTA and a paraben dispersed or dissolved therein. In yet another embodiment, the solution further comprises a photo-oxidant, such as, for example, methylene blue, dissolved in the solution.

In still another form, the invention provides devices, methods and compositions relating to the pretreatment of a catheter or other medical implant prior to use. In one embodiment, the catheter is soaked in a solution including EDTA for a period of time, and thereby impregnated with the EDTA to provide a catheter featuring resistance to infection. Such soaking solutions preferably include the EDTA at a high concentration.

In yet another aspect of the invention, there is provided a kit for locking a patient's catheter. The kit includes a container having therein a catheter lock solution, and instructions, recorded in a medium, for infusing the solution into a lumen of an indwelling catheter. In one embodiment, the catheter lock solution comprises citrate, a paraben and EDTA dispersed or dissolved therein. In another embodiment, the catheter lock solution comprising EDTA and a paraben dispersed or dissolved therein. The catheter can be selected from the group consisting of an intravascular catheter and a body cavity catheter. In yet another embodiment, the solution further comprises a photo-oxidant, such as, for example, methylene blue, dissolved in the solution.

The invention will be further described with reference to the following specific Examples. It will be understood that these Examples are intended to be illustrative and not restrictive in nature.

### Example 1

A catheter lock solution is prepared in accordance with the invention to include citrate at a concentration of 7%, by weight (provided as trisodium citrate), methyl paraben at a concentration of 0.15%, by weight, propyl paraben at a concentration of 0.015% by weight and EDTA at a concentration of 1%. The target pH of the catheter lock solution is 4.5.

### Example

A catheter lock solution is prepared in accordance with the invention to include citrate at a concentration of 7%, by weight (provided as trisodium citrate), methyl paraben at a concentration of 0.15%, by weight, propyl paraben at a concentration of 0.015% by weight and EDTA at a concentration of 1%. The target pH of the catheter lock solution is 6.2.

### Example 3

A catheter lock solution is prepared in accordance with the invention to include citrate at a concentration of 7%, by weight (provided as trisodiurn citrate), methyl paraben at a concentration of 0.15% by weight, propyl paraben at a concentration of 0.015% by weight, methylene blue at a concentration of 0.015% by weight and EDTA at a concentration of 1% by weight. The target pH of the solution is 6.2.

### Example 4

### Manufacturing of a Representative Catheter Lock Solution

### Method

A catheter lock solution is formulated as a sterile mixture of USP grade chemicals in the following concentrations: 7% citrate solution by weight, 0.15% methyl paraben by weight, 0.015% propyl paraben by weight, 0.015% methylene blue by weight and 1% EDTA by weight. The solution is designed to have a relative density of 1.035 to 1.045, and pH of about 6.2. The citrate solution is prepared at the desired pH (6.2) by mixing 428 ml of 0.24 M trisodiurn citrate dihydrate solution (70.58 g/L) and 72 ml of 0.24 M anhydrous citric acid solution (46.10 g/L). The final solution is obtained by adding 0.15 g of methyl paraben, 0.015 g of propyl paraben, 0.15 g of methylene blue and 1 g of EDTA per 100 ml of citrate solution in the actual batch size. The solution is stored at room temperature.

The bulk solution is then pumped into an aseptic filling area, passing through a secondary and then primary 0.2 micron sterilizing filter before flowing into a sterilized surge type or pressure type vessel. The sterilized solution in the sterile vessel flows to the filler where light resistant, type 1 glass vials (5 mL, Kimble, type 1 Borosilicate Glass Amber Vial, 13-mm Finish, Untreated) are conveyed and filled with the predetermined fill volume. The filled vials are then conveyed to the stoppering location where stoppers (West, 13 mm, 4432/50 Rubber Stopper) are placed in the vials. The vials are then conveyed to a capping machine which applies aluminum crimp seals with flip off caps to each vial (West, 13 mm Aluminum Seal, Flip-off Button). Overseals (crimped caps) are applied in a capping area outside of the aseptic processing area.

The filled, stoppered and capped vials are then inspected for visible particulate matter and other defects.

The starting materials for making the solution of this embodiment are readily available commercially.

### Example 5

### Using an Inventive Catheter Lock Solution

At the end of a patient's hemodialysis treatment each lumen of the catheter is filled with the lock solution in an amount equal to the fill volume of the catheter lumen. Each lumen is filled to the tip using a quick bolus technique for the first ⅔ of the injected volume, and slow infusion (over 10 seconds) for the last ⅓ of the injected volume.

The catheter lock solution is removed before each dialysis procedure, by attaching a syringe to each catheter lumen and removing 1 mL more than the catheter lumen volume (about 3 mL total), discarding the syringe, then flushing the catheter with 5 mL of sterile normal saline.

While the invention has been described in detail herein, the same is to be considered illustrative and not restrictive in character, it being understood that only selected embodiments have been shown and described and that all changes, equivalents, and modifications that come within the scope of the inventions described herein or defined by the following claims are desired to be protected. Any theory, mechanism of operation, proof, or finding stated herein is meant to further enhance understanding of the present invention and is not intended to limit the present invention in any way to such theory, mechanism of operation, proof, or finding. Further, any U.S. patent or pending U.S. Patent Application Publication or other publication cited herein is incorporated herein by reference in its entirety as if each individual publication, patent, or patent application was specifically and individually indicated to be incorporated by reference and set forth in its entirety herein. In reading the claims, words such as “a”, “an”, “at least one”, and “at least a portion” are not intended to limit the claims to only one item unless specifically stated to the contrary. Further, when the language “at least a portion” and/or “a portion” is used, the claims may include a portion and/or the entire item unless specifically stated to the contrary.

The present invention contemplates modifications as would occur to those skilled in the art without departing from the spirit of the present invention. In addition, the various procedures, techniques, and operations may be altered, rearranged, substituted, deleted, duplicated, or combined as would occur to those skilled in the art. Unless specifically identified to the contrary, all terms used herein are used to include their normal and customary terminology. Further, while various embodiments having specific components are described and illustrated herein, it is to be understood that any selected embodiment can include one or more of the specific components described for another embodiment where possible.

1. An aqueous catheter lock solution comprising citrate, a paraben and EDTA dispersed or dissolved therein.

2. The solution according to claim 1 wherein the solution comprises a paraben selected from the group consisting of methyl paraben, ethyl paraben, propyl paraben, butyl paraben and mixtures of any two or more of said members.

3. The solution according to claim 1 wherein the solution comprises methyl paraben.

4. The solution according to claim 3 wherein the concentration of methyl paraben in the solution is from about 0.005 to about 0.5 percent.

5. The solution according to claim 1 wherein the solution comprises propyl paraben.

6. The solution according to claim 5 wherein the concentration of propyl paraben in the solution is from about 0.005 to about 0.5 percent.

7. The solution according to claim 1 wherein the solution comprises a mixture of methyl paraben and propyl paraben.

8. The solution according to claim 7 wherein the concentration of methyl paraben in the solution is from about 0.05 to about 0.5 percent and the concentration of propyl paraben in the solution is from about 0.005 to about 0.5 percent.

9. The solution according to claim 1 wherein the concentration of citrate in the solution is from about 1.5 to about 50% by weight.

10. The solution according to claim 1 wherein the concentration of citrate in the solution is from about 10 to about 50% by weight.

11. The solution according to claim 1 wherein the concentration of citrate in the solution is from about 1.5 to about 23% by weight.

12. The solution of according to claim 1 wherein the citrate has a concentration of from about 1.5 to about 50 percent and the paraben has a concentration of from about 0.005 to about 0.6 percent.

13. The solution according to claim 1 wherein the citrate is provided in the solution in the form of trisodium citrate dihydrate.

14. The solution according to claim 1 wherein the concentration of EDTA in the solution is from about 0.03 to about 10% by weight.

15. The solution according to claim 1 wherein the concentration of EDTA in the solution is from about 0.1 to about 5% by weight.

16. The solution according to claim 1 wherein the concentration of EDTA in the solution is from about 0.5 to about 1.5% by weight.

17. The solution according to claim 1 wherein the pH of the solution is from about 4 to about 8.

18. The solution according to claim 1 wherein the relative density of the solution is from about 1.000 to about 1.300 g/ml.

19. The solution according to claim 1, further comprising a viscosifying agent.

20. The solution according to claim 19 wherein the viscosifying agent comprises a member selected from the group consisting of dextran, polyethylene glycol, glycerin, polygeline, non-metabolizable sugars such as sorbitol and mannitol, and mixtures of these compounds.

21. The solution according to claim 1, further comprising a photo-oxidant dissolved in the solution.

22. The solution according to claim 21 wherein the photo-oxidant comprises a member selected from the group consisting of methylene blue, Rose Bengal, hypericin, methylene violet, proflavine, riboflavin, rivanol, acriflavine, toluide blue, trypan blue, neutral red and mixtures thereof.

23. The solution according to claim 21 wherein the photo-oxidant comprises methylene blue.

24. The solution according to claim 23 wherein the concentration of methylene blue in the solution is up to about 1500 mg/100 ml.

25-43. (canceled)

44. A method for treating a patient, comprising:
selecting a patient having an indwelling catheter defining a lumen therethrough; and
infusing an aqueous catheter lock solution into the lumen, the solution comprising citrate, EDTA and a paraben dispersed or dissolved therein.

45. The method of claim 44 wherein the catheter is selected from the group consisting of an intravascular catheter and a body cavity catheter.

46. The method according to claim 45 wherein the solution further comprises a photo-oxidant dissolved in the solution.

47. The method according to claim 46 wherein the photo-oxidant comprises methylene blue.

48-49. (canceled)

50. A method for sanitizing a surface, comprising:
providing an aqueous solution comprising EDTA and a paraben dispersed or dissolved therein at concentrations whereby the solution is effective to cause at least a 1 log kill in a population of microorganisms on a surface treatment area within about 60 seconds of contact;
selecting a surface to be sanitized; and
contacting the solution with the surface for a period of time sufficient to cause at least a 6 log decrease in the population of microorganisms.

51. The method of claim 50 wherein the surface is selected from the group consisting of a skin area, a wound, a catheter surface, an medical instrument surface and a table.

52. The method according to claim 51 wherein the solution further comprises a photo-oxidant dissolved in the solution.

53. The method according to claim 52 wherein the photo-oxidant comprises methylene blue.

54. The method according to claim 51 wherein the solution further comprises citrate dissolved in the solution.

55. The method according to claim 51 wherein the solution further comprises citrate and a photo-oxidant dissolved in the solution.

56-71. (canceled)
